(19) United States
(12) Patent Application Publication
(10) Pub. No.: US 2021/0242823 A1
(43) Pub. Date: Aug. 5, 2021

(54) ASSEMBLY OF FLEXIBLE SOLAR PANEL FOR EXPANDABLE AWNING

(71) Applicant: Nicholas Benton Cohenmeyer, San Diego, CA (US)

(72) Inventor: Nicholas Benton Cohenmeyer, San Diego, CA (US)

(21) Appl. No.: 16/780,883

(22) Filed: Feb. 3, 2020

(51) Int. Cl. H02S 20/30; H02S 30/20; H02S 40/34; B60P 3/34; E04H 15/08

(52) U.S. Cl. CPC H02S 20/30; H02S 30/20; H02H 7/20; B60P 3/343; E04H 15/08; H02S 40/34

(57) ABSTRACT

The present invention relates to the field of flexible solar panel. The present invention particularly relates to an assembly of flexible solar panel that may be integrated into expandable awning. More particularly, the aforementioned flexible solar panel for integration into roll-out awnings of recreational vehicles and motor coaches. Some coaches already have solar panels integrated into their roofs or other exposed areas.

### CROSS REFERENCE OF RELATED PATENT APPLICATIONS

This application claims the benefit of priority to U.S. Provisional Patent Application Ser. No. 62/783,933, filed Jan. 8, 2019, the entirety of which is incorporated herein by reference.

### FIELD OF THE INVENTION

The present invention relates to the field of flexible solar panel. The present invention particularly relates to an assembly of flexible solar panel that may be integrated into expandable awning. More particularly, the aforementioned flexible solar panel for integration into roll-out awnings of recreational vehicles and motor coaches. Some coaches already have solar panels integrated into their roofs or other exposed areas.

### BACKGROUND OF THE INVENTION

It is known to provide a roll-type awning for extension over a slide-out room of a recreational vehicle to prevent rain and debris from accumulating on the roof of the slide-out room. Such awnings generally consist of an awning fabric which is unwound from an awning roll over the roof of the slide-out room. The roll may be attached to a stationary outside wall of the recreational vehicle above the slide-out room and a free end of the fabric attached to the outside edge of the slide-out room's roof. An example of such an awning is described in U.S. Pat. No. 6,269,824 to Brutsaert.

Alternatively, the roll may be attached the slide-out room and the free end of the fabric attached to the stationary outside wall of the recreational vehicle. An example of a such an awning is disclosed in U.S. Pat. No. 5,752,536 to Becker.

With either awning arrangement, when the slide out room is extended, the awning fabric automatically extends over the roof of the slide-out room. The awning fabric is sloped downward away from the outside wall of the recreational vehicle to direct water and debris away from the recreational la vehicle and the slide-out room.

Further, both of these designs include awning rolls which are mounted externally on the recreational vehicle giving the vehicle a cluttered appearance and creating aerodynamic drag, resulting in wind noise when the vehicle is in motion.

Electricity produced by solar cells would have a bigger impact were it not so expensive. The cost of the raw materials, equipment, and energy required to manufacture crystalline and polycrystalline solar cells is prohibitive for widescale market penetration. Presently, it is cheaper to produce electricity with coal fired or nuclear plants. As much as half the cost of solar cells lies in an expensive substrate such as crystalline silicon. A less expensive substrate is desirable.

The arrangement of cells into solar modules or arrays creates enormous industry-wide manufacturing problems. The cost and complexity of conventional solar panels conspire against the deployment of solar cells in many applications, such as portable electronics and computers. Crystalline thick-film solar cells are also fragile and bulky, which minimizes their acceptability in the marketplace. They are less rugged than conventional materials such as roof tiles. They are expensive to transport because they must be carefully protected from breakage. A flexible solar cell, if available, would be more rugged, less likely to break, and could be rolled up for easy transport or shipping.

### OBJECTIVE OF THE INVENTION

In light of the above, the main objective of the present invention is to provide such an assembly that may be a flexible solar panel that may be integrated into expandable awning.

Another objective of the present invention is to provide a flexible solar panel for integration into roll-out awnings of recreational vehicles and motor coaches.

### SUMMARY OF THE INVENTION

Generally, one aspect of the invention discloses an assembly of flexible solar panel for integration into roll-out awnings of recreational vehicles and motor coaches.

In another aspect, the present invention discloses the flexible solar panel of the present disclosure is thin and sewn, glued, or stapled into the fabric of the awning.

In still another aspect, the present invention discloses that when the awning is extended, the large, otherwise unused real-estate of the awning is generating solar electricity to trickle charge the coach.

In yet another aspect, the present invention disclose that the awning either retracts manually or electrically and coils into a roll that stays encased along the passenger side (portside) of the coach.

Other aspects of the present invention are disclosed in the appended drawings and the following description.

### DETAILED DESCRIPTION OF DRAWING(S)

Other feature, advantages and details are only presented in the detailed description of following implementation in the illustrated manner, detailed description refers to the attached drawing, in which:

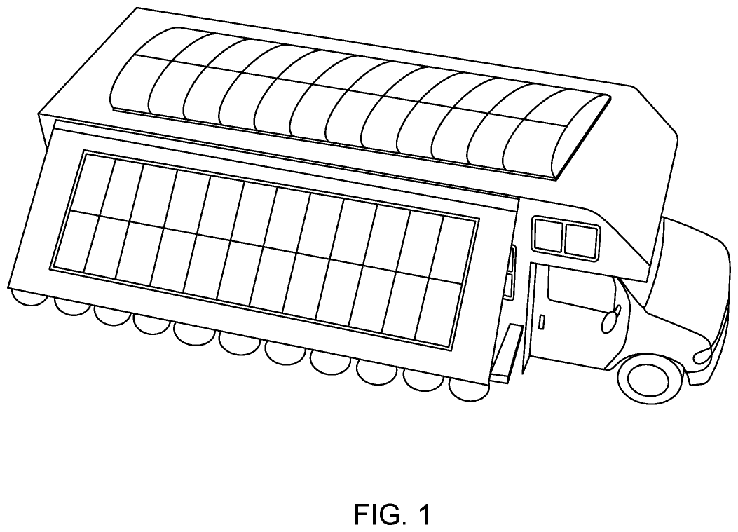

FIG. 1 illustrates one of the top perspective view of the assembly of flexible solar panel of the in accordance with the embodiments of the present invention.

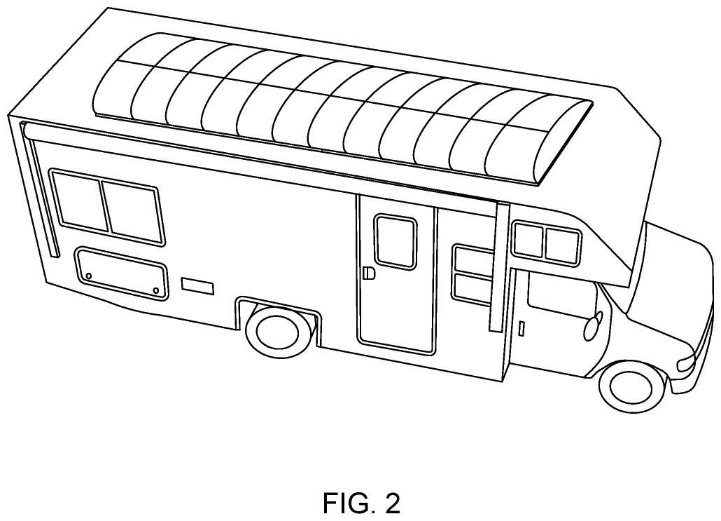

FIG. 2 illustrates another perspective view of the assembly of flexible solar panel of the in accordance with the embodiments of the present invention.

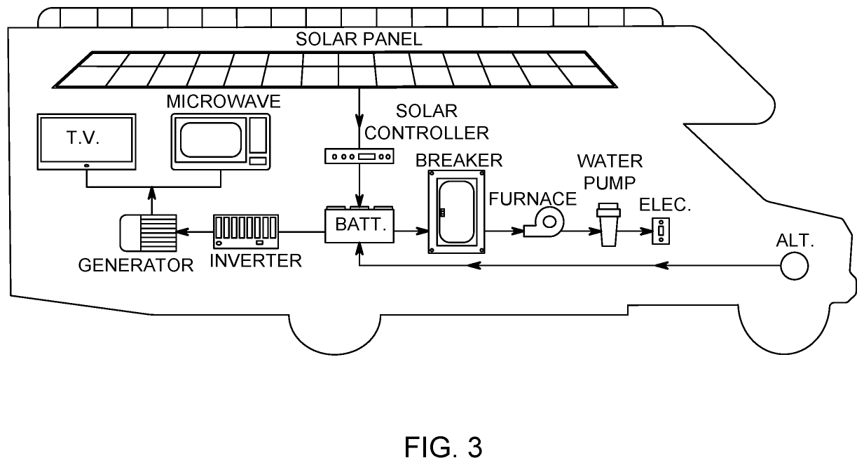

FIG. 3 illustrates a perspective view of components of the assembly of flexible solar panel of the in accordance with the embodiments of the present invention.

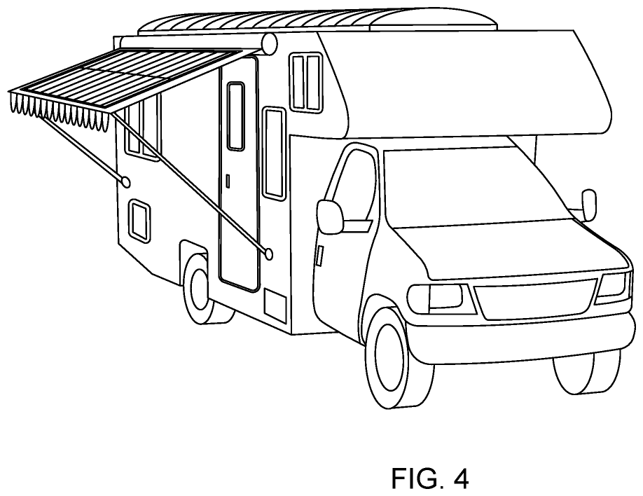

FIG. 4 illustrates another perspective view of the assembly of flexible solar panel of the in accordance with the embodiments of the present invention.

### DETAILED DESCRIPTION OF THE INVENTION

The present invention may be understood more readily by reference to the following detailed description of the invention taken in connection with the accompanying drawing figures, which forms a part of this disclosure. It is to be understood that this invention is not limited to the specific devices, methods, conditions or parameters described and/or shown herein and that the terminology used herein is for the example only and is not intended to be limiting of the claimed invention. Also, as used in the specification including the appended claims, the singular forms ‘a’, ‘an’, and ‘the’ include the plural, and references to a particular numerical value includes at least that particular value unless the content clearly directs otherwise. Ranges may be expressed herein as from ‘about’ or ‘approximately’ another particular value. when such a range is expressed another embodiment. Also, it will be understood that unless otherwise indicated, dimensions and material characteristics stated herein are by way of example rather than limitation, and are for better understanding of sample embodiment of suitable utility, and variations outside of the stated values may also be within the scope of the invention depending upon the particular application.

Embodiments will now be described in detail with reference to the accompanying drawings. To avoid unnecessarily obscuring the present disclosure, well-known features may not be described or substantially the same elements may not be redundantly described, for example. This is for ease of understanding.

The drawings and the following description are provided to enable those skilled in the art to fully understand the present disclosure and are in no way intended to limit the scope of the present disclosure as set forth in the appended claims.

Off-road vehicles are powered in a conventional manner: First, the external power supply directly, two full-road vehicles use stored battery power supply, the third is equipped with a generator to provide power at any time. External power supply, which greatly limits the docking areaMotorhome, Motorhome affect the continued use of electrical appliances; the use of battery power, there are also battery lifetime is short; although before generator power can successfully handle both problems, but the weight of the generator itself, volume and other factors, the increase in the overall design of the vehicle living during the off-road vehicles with a weight factor to consider aspects of the placement and the like. Thus, Motorhomes been seriously affected by the use of self-powered solution is.

Nearly all modern motorhomes and trailers are sold with a large roll-out awning to provide shade from the elements. The awning either retracts manually or electrically and coils into a roll that stays encased along the passenger side (starboard side) of the coach. Such awnings represent unused space by the motorhome owner. Further, motorhomes use large amounts of electricity with their batteries drained by appliance use when the vehicle is stopped for overnight camping.

Systems and methods described herein provide a flexible solar panel for integration into roll-out awnings of recreational vehicles and motor coaches. Some coaches already have solar panels integrated into their roofs or other exposed areas.

In one embodiment of the present invention, an assembly of flexible solar panel is disclosed that may be thin and sewn, glued, or stapled into the fabric of the awning. When the awning is extended, the large, otherwise unused real-estate of the awning is generating solar electricity to trickle charge the coach. The awning either retracts manually or electrically and coils into a roll that stays encased along the passenger side (portside) of the coach.

In another embodiment of the invention, the aforementioned assembly of flexible solar panel comprises a combination of crucial components.

In another embodiment of the invention, the aforementioned assembly comprises an extended solar panel to absorb sunlight as a source of energy to generate electricity. A photovoltaic (PV) module is a packaged, connected assembly of typically 6×10 photovoltaic solar cells. Photovoltaic modules constitute the photovoltaic array of a photovoltaic system that generates and supplies solar electricity in commercial and residential applications.

In another embodiment of the invention, the aforementioned assembly comprises solar controller to regulate the amount of charge coming from the panel that flows into the deep cycle battery bank in order to avoid the batteries being overcharged. A regulator can also provide a direct connection to appliances, while continuing to recharge the battery. That is, you can run appliances directly from it, bypassing the battery bank; but the batteries will continue to be charge.

In another embodiment, the aforementioned assembly comprises a battery to convert solar energy to electric energy wherein the power generated in the battery is 12-volt DC voltage and you have to convert it to AC current to run your home appliances that run on AC power. You have to install a power inverter to convert the DC power of the battery to an AC power for supporting your home devices.

In another embodiment, the aforementioned assembly comprises inverter to convert direct current (DC) to alternating current (AC) wherein an inverter increases the DC voltage, and then changes it to alternating current before sending it out to power a device. These devices were initially designed to do the opposite to convert alternating current into direct current.

In another embodiment, the aforementioned assembly comprises generator for converting mechanical energy into electricity to be eventually supplied to all the appliances and maintaining power supply through out the vehicle. They include a rotor with a hollow core that rotates around a stator. The stator is typically a powerful magnet, while the coils that carry electricity are wound around the rotor. In some generators, the coils are wound around the stator and the rotor is magnetized. Either way, electricity will flow.

In another embodiment, the aforementioned may comprise a circuit breaker that may be automatically operated electrical switch designed to protect an electrical from damage caused by excess from overload or short circuit. In another embodiment, the assembly may comprises a furnace and pump that may be heated that to be circulating throughout the arrangement of healthy system.

It is pertinent to note that the aforementioned assembly may be integrated and designed not limiting to for any kind of motorhomes or caravan or camper or recreational vehicle or RV or trailer.

In another embodiment, the aforementioned motor-home may comprise an additional half-cylindrical solar panel on the roof of the motor home in such a way that the roof top equipment (air-conditioner etc.) would be hidden underneath the solar cylinder. This special arrangement of the addition solar panel may enable a much elongated and larger solar panel that would run throughout the length of the roof top of the motor home.

In another embodiment, the aforementioned additional elongated solar panel may be curved in a way such that there is always a constant exposure of the sunlight on the surface of the solar panel which would enable the conservation of the solar energy for the various utility of the motor homes.

In another embodiment, the aforementioned additional elongated solar panel may half cylindrical and may be hinged on one side so that it may be opened when access to the roof top equipment is required.

In another embodiment, the aforementioned assembly in the form of power rationing motor home breaks through the traditional use of the external power supply and the power supply of the power generation by the solar panel abundant natural resources, solar energy directly into electric energy stored in the battery-road vehicles in the case of off-road vehicles in order to disconnect the external power supply or with the generator, the energy stored in the battery is residing in the vehicle lighting appliances, bathroom appliances, kitchen appliances and multimedia appliances power, thus achieving the duration of power off-road vehicles long, high conversion efficiency, ease of use and other advantages.

In another embodiment, the charging circuit for the aforementioned assembly is connected to utility mains voltage, the battery charge controller detects the end of the charging the charging voltage is higher than the mains voltage of the solar charging, the battery is identified as fully charged, the solar charging circuit stops charging a secondary battery, mains a charging circuit charging a secondary battery, electrical power may also be used.

The charging circuit is not connected to the mains the mains voltage, electrical appliances used in normal conditions, the battery life of three to five days, when the sunlight during the day, the solar charging circuit charging a secondary battery, can effectively extend the-road vehicles battery operating time.

Wires connected to the solar panel run through a channel on a side of the awning. The wires are coiled along with the material of the awning and the solar panel. The wires feed into a solar converter that feeds to the house batteries of the vehicle which may feed all systems except the vehicle's drivetrain. The solar panel effectively becomes a component of the awning such that the panel rolls or folds up into the awning when the awning closes.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, this disclosure encompasses any suitable combination of one or more features from any example embodiment with one or more features of any other example embodiment herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An assembly of flexible solar panel for expandable awning comprising:
a) an extended solar panel to absorb the solar radiation or rays for generating electrical (or) thermal energy;
b) a solar controller to regulate and balance the charge of the connected battery;
c) a battery to convert solar energy to electric energy;
d) investor to convert direct current (DC) to alternating current (AC);
e) generator for converting mechanical energy into electricity to be eventually supplied to all the appliances and maintaining power supply through out the vehicle;
f) an additional over the top system half-cylindrical solar panel that provides concealing to the entire surface of the motor-home and protection of the essential vital equipments of the same.

2. The assembly of flexible solar panel for expandable awning as claimed in claim 1, wherein the extended solar may be thin and flexible.

3. The assembly of flexible solar panel for expandable awning as claimed in claim 1, wherein the extended solar panel may be sewn, glued or stapled into the fabric awning.

4. The assembly of flexible solar panel for expandable awning as claimed in claim 1, wherein the may aid in generating solar electricity to trickle charge of the coach.

5. The assembly of flexible solar panel for expandable awning as claimed in claim 1, wherein said awning may either retracts manually or electrically and coils into a roll that would be encased along the passenger side or port side of the coach.

6. The assembly of flexible solar panel for expandable awning as claimed in claim 1, wherein the input voltage, output voltage, frequency and over all power handling of said investor depending on the design of the specific device or circuitry.

7. The assembly of flexible solar panel for expandable awning as claimed in claim 1, wherein the aforementioned assembly further comprises a circuit breaker that may be automatically operated electrical switch designed to protect an electrical from damage caused by excess from overload or short circuit.

8. The assembly of flexible solar panel for expandable awning as claimed in claim 1, wherein the aforementioned assembly further comprises a furnace and pump that may be heated that to be circulating throughout the arrangement of healthy system.

9. The assembly of flexible solar panel for expandable awning as claimed in claim 1, the half cylindrical over the top solar panel may run over entire the roof surface of the motor home.

10. The assembly of flexible solar panel for expandable awning as claimed in claim 1, the half cylindrical over the top solar panel may be hinged on one side in such a way so that it could be opened when access to roof top equipment is required.

11. The assembly of flexible solar panel for expandable awning as claimed in claim 1, wherein the aforementioned assemble may further comprise wires that may be connected to the solar panel run through a channel on a side of the awning.

12. The assembly of flexible solar panel for expandable awning as claimed in claim 1, wherein said wire are coiled along with material of the awning and the solar panel.

13. The assembly of flexible solar panel for expandable awning as claimed in claim 1, wherein said wires may be into a solar converter that feeds to the house batteries of the vehicle which may feed all systems except the vehicle's drivetrain.

14. The assembly of flexible solar panel for expandable awning as claimed in claim 1, wherein the entire aforementioned assembly may be integrated to any kind of modern motorhomes.
